(19) United States
(12) Patent Application Publication
(10) Pub. No.: US 2008/0033645 A1
(43) Pub. Date: Feb. 7, 2008

(54) POBABILISTIC METHODS FOR MAPPING AND LOCALIZATION IN ARBITRARY OUTDOOR ENVIRONMENTS

(76) Inventors: Jesse Sol Levinson, Hillsborough, CA (US); Sebastian Thrun, Stanford, CA (US); Michael Steven Montemerlo, Palo Alto, CA (US)

Correspondence Address: WONG, CABELLO, LUTSCH, RUTHERFORD & BRUCCULERI,;L.L.P., 20333 SH 249, SUITE 600, HOUSTON, TX, 77070, US

(21) Appl. No.: 11/462,289

(22) Filed: Aug. 3, 2006

(51) Int. Cl. G01C 21/00

(52) U.S. Cl. 701/213; 701/208

(57) ABSTRACT

Systems and methods which provide mapping an arbitrary outdoor environment and positioning a ground-based vehicle relative to this map. In one embodiment, a land-based vehicle travels across a section of terrain, recording both location data from sensors such as GPS as well as scene data from sensors such as laser scanners or cameras. These data are then used to create a high-resolution map of the terrain, which may have well-defined structure (such as a road) or which may be unstructured (such as a section of desert), and which does not rely on the presence of any “landmark” features. In another embodiment, the vehicle localizes itself relative to this map in a subsequent drive over the same section of terrain, using a computer algorithm that incorporates incoming sensor data from the vehicle by attempting to maximize the likelihood of the observed data given the map.

### BACKGROUND OF THE INVENTION

1. Field of the Invention

The present invention relates to software algorithms that integrate various sensor data for the purpose of building high resolution maps for use by a land-based vehicle and to accurately and reliably determine the position of the land-based vehicle.

2. Description of the Related Art

Interest in precision localization of moving vehicles is increasing rapidly. Accurate and reliable localization is necessary for guidance of unmanned ground vehicles, with such vehicles affording significant military and consumer applications. Accurate and reliable localization is also necessary for an array of systems that assist human drivers in the form of navigational aids and safety-related assistance systems.

Present techniques for localizing outdoor vehicles rely almost entirely on Global Position System (GPS) satellites, which allow a receiver to observe signals from multiple geosynchronous satellites and thereby triangulate its position. Although GPS has been successful for many types of navigation, it does not meet the needs of many other applications. Whereas GPS accuracy and coverage is sufficient for most air and sea navigation, it possesses several limitations that make it insufficient on its own for an array of navigation-related problems on the ground. Even the best GPS systems available frequently yield worse accuracy than half a meter, an error that may be intolerably large for unmanned vehicle guidance, or for certain driver assistance systems. A second problem is reliability. GPS often drops out when the sky is occluded, such as when a vehicle is in a city with tall buildings, in an underpass or tunnel, or when on a bridge. Loss of data for even brief periods can lead to unreliable systems.

Technologies such as the Ground Based Augmentation system or repeated land-based transmitters have been used to provide increased coverage and localization accuracy in select environments. While such systems are successful, they exist only in a small fraction of locations. Furthermore, their installation is prohibitively expensive and time consuming for the vast majority of environments, and is simple infeasible in many. Because such systems require a high initial monetary and time cost, they are not generally applicable to outdoor navigation in arbitrary environments.

Other technologies use sensors such as cameras to capture specific identifiable objects in the environment, and store them in a database for comparison with images taken at a later date. For example, the position and appearance of a large object such as the Eiffel Tower might be recorded for later use in localization. While such techniques are sometimes effective, they rely generally on easily-identifiable landmarks and are prone to error and inaccuracy, especially under unpredictable lighting. These systems are thus ill-suited for reliable, high-accuracy localization.

Some technologies employ GPS for mapping and subsequent localization relative to the map. For example, some companies use GPS to create databases of roads in global coordinates. Commercial vehicles use databases such as these to localize relative to the map, using a combination of GPS data, odometry data, and map data. For example, a commercial navigation system will attempt to fit data from GPS, wheel revolution measurements, and steering angle, to an appropriate region of the database's map file. While such techniques are often effective in providing a vehicle's location relative to such a map, the maps themselves are of insufficient accuracy to provide for fully autonomous driving or for driver assistance systems that require high precision. For example, while they may allow a vehicle to determine what road it is on and approximately where along the road it is, they are unable to determine which lane the vehicle is in, let alone an accurate location within the lane. Thus the limited accuracy and fundamental reliance only on GPS and odometry data prohibit such systems from achieving sufficient accuracy for many problems related to ground navigation.

The fields of mapping and navigation have received enormous interest recently in the AI and robotics communities. Simultaneous Localization and Mapping, or SLAM, addresses the problem of building consistent environment maps from a moving robotic vehicle, while simultaneously localizing the vehicle relative to these maps. SLAM has been at the core of a number of successful autonomous robot systems.

Nearly all SLAM work has been developed for static indoor environments. In some sense, indoor environments are more difficult to map than outdoor environments, since indoor robots do not have access to a source of global accurate position measurements such as GPS.

This has created a need for methods that enable vehicles to make accurate maps and localize outdoors. At first glance, outdoor SLAM is significantly easier than indoor SLAM, thanks to the availability of GPS. In fact, one might (falsely) argue that GPS solves the localization aspect of the SLAM problem, so that all that is left is the mapping problem. However, this is not the case. Even in areas where GPS is available, the localization error often exceeds one meter.

Such errors are too large for precision vehicle navigation. This problem is even more severe in urban environments where GPS reception is often blocked by buildings and vegetation, and signals are subject to multipath reflections. As a result, GPS-based localization in cities is often inaccurate and too unreliable for autonomous robot driving. This renders GPS alone unsuitable for vehicle guidance on the ground.

Therefore, there is a need in the field of land-based outdoor navigation for systems and methods for robust and highly accurate positioning in outdoor environments.

### SUMMARY

Systems and methods according to the present invention provide mapping of an arbitrary outdoor environment and positioning a ground-based vehicle relative to this map. In one embodiment according to the invention, a land-based vehicle travels across a section of terrain, recording both location data from sensors such as GPS as well as scene data from sensors such as laser scanners or cameras. These data are then used to create a high-resolution map of the terrain, which may have well-defined structure (such as a road) or which may be unstructured (such as a section of desert), and which does not rely on the presence of any “landmark” features.

In another embodiment, the vehicle localizes itself relative to this map in a subsequent drive over the same section of terrain, using a computer algorithm that incorporates incoming sensor data from the vehicle by attempting to maximize the likelihood of the observed data given the map.

### BRIEF DESCRIPTION OF THE DRAWINGS

FIG. 1 is a block diagram illustrating a system for logging sensor data in an outdoor environment via a moving land-based vehicle.

FIG. 2 is a block diagram illustrating a system for generating a high-resolution environment map from logged sensor data.

FIG. 3 is a block diagram illustrating a system for localizing relative to a map in an outdoor environment via a moving land-based vehicle.

FIG. 4 is an orthographic two-dimensional slice of an urban road consisting of all data within a small tolerance of the ground plane.

FIG. 5 is three-dimensional projection of LIDAR scans of an urban road illustrating ground plane and non-ground plane data.

FIG. 6 is a visualization of particles representing individual hypothesis for vehicle location overlaid on previously-generated environment data.

FIG. 7 is a flowchart of map calculation operations according to the preferred embodiment.

FIG. 8 is a flowchart of localization operations according to the preferred embodiment.

### DETAILED DESCRIPTION OF THE PREFERRED EMBODIMENTS

In an unmanned vehicle, driving autonomously on today's roads, it is necessary to obtain an accurate position estimate that provides a precise location within a lane, with a precision of a few centimeters, and in GPS-denied environments (e.g., in a tunnel). In the preferred embodiment a human first drives a vehicle on a network of roads, with the vehicle recording position data from a GPS receiver and scene data from laser scanners, which are processed into a high-resolution map file. Later, a vehicle, manned or unmanned, drives on this same network of roads, and using its sensors is able to determine its position on the road relative to the map file with significantly greater accuracy than GPS alone affords. It can also determine its position when GPS is temporarily unavailable, e.g., in narrow urban canyons. The resulting precision and reliability is a key prerequisite of autonomous unmanned ground vehicle operation.

In an in-car navigation system, the ability to track vehicle position to within higher resolution than GPS allows extra features that benefit a human driver. For example, according to the present invention it is possible to obtain a precise location estimate which easily specifies which lane the vehicle is in. This information allows the vehicle's navigation system to provide helpful information to the driver beyond that which is possible with current technology. For example, the system may warn a human driver if she departs from a lane on a highway without an expressed intent to do so (e.g., setting the turn signals). It also may assist a human driver in the decisions as to when to change lanes, such as when approaching a turn. Furthermore, the vehicle can maintain its position accuracy even in the absence of GPS signals, for example in tunnels, offering those assistances to human drivers even in GPS-denied environments.

In an unknown or hostile desert environment, an autonomous ground vehicle drives around while recording position and scene data. These data are converted into a high-resolution map file which is then analyzed and annotated by human experts, such as for military purposes. The autonomous vehicle is then able to follow specific missions with high accuracy and drive to targets with higher precision than would be possible with GPS alone. Furthermore, this system would be equally advantageous in areas devoid of GPS coverage. In this case, the system would produce position estimates using wheel odometry and inertial measurement unit data and still be able to follow precise routes and drive to targets effectively.

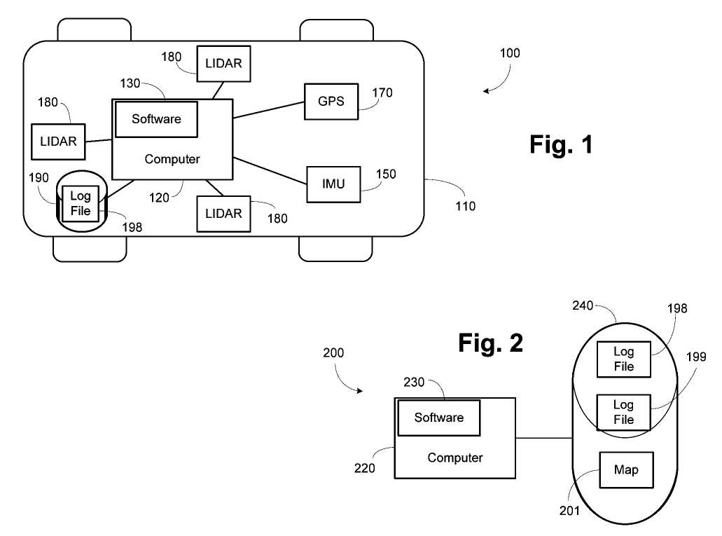

FIG. 1 is a block diagram illustrating a system 100 for mapping an outdoor environment via a land-based moving vehicle 110 according to one embodiment of the present invention. The system 100 comprises the vehicle 110, containing a computer 120 running computer software 130; an inertial measurement unit (IMU) 150; an odometry readout system 160; a GPS system 170; an environmental sensor system 180, such as a Light Detection and Ranging (LIDAR) or laser system; and a data storage medium 190 for storing an outputted data log file 198. The vehicle 110 provides power to devices 120-180.

A computer 120 runs software algorithms 130 which log data from sensors 150, 160, and 170 and environment or LIDAR sensors 180. Sensors 150-180 are mounted in or on the vehicle 110 and are connected to computer 120 via digital communication interfaces. The computer 120 can be any variety, capable of receiving data via these interfaces. An operating system such as Mac OS X, Windows, or Linux can be adapted to integrate software 130. Computer 120 incorporates a storage medium 190, such as a hard disk drive with sufficient storage to main a log file 198 of data from sensors 150-180.

Sensor 150 is an inertial measurement unit which reports to software 130 via computer 120 changes in x, y, and z acceleration and rotational acceleration about all three axes. Sensor 160 comprises odometry information obtained directly from vehicle 110, such as over an industry-standard CAN interface. This information preferably comprises wheel revolution speeds for each wheel and steering angle. These data are sent to software 130 via computer 120. Sensor 170 is a Global Positioning System receiver that obtains position estimates in global coordinates based on data from multiple geosynchronous satellites. These data are sent to software 130 via computer 120. In one embodiment, sensors 150, 160, and 170 are integrated via commercial off-the-shelf software so as to increase the overall reliability and accuracy of the vehicle position estimation. In another embodiment, the data from these sensors are treated separately until they are integrated directly into the software 130. Sensors 180 preferably comprise one or more LIDAR measurement systems which return distance and intensity or reflectivity data at a high data rate. In one embodiment, three sensors 180 are mounted on vehicle 110, one positioned on the left side facing left, one positioned on the right side facing right, and one positioned on the rear side facing rear. The data from the LIDAR sensors 180 is also sent to the software 130 via computer 120.

FIG. 2 is a block diagram illustrating a system 200 for creating a high-resolution map from logged sensor data. System 200 comprises a computer 220 running software 230 which takes as input the log file 198 and outputs a map file 201, both stored on a storage medium 240. Optionally, an intermediate log file 199 may be created and utilized.

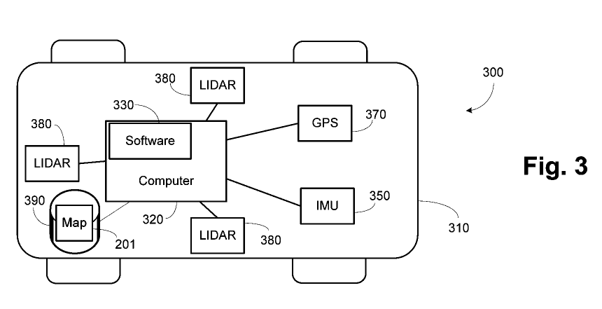

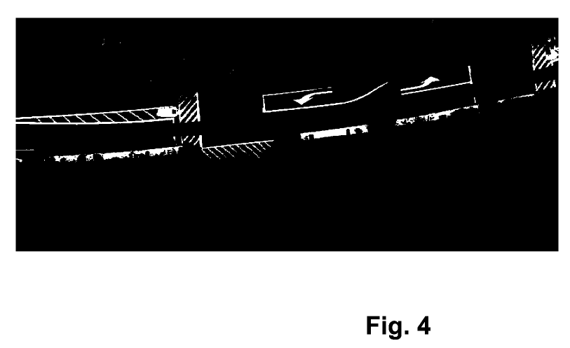

FIG. 3 is a block diagram illustrating a system 300 for localizing in an outdoor environment via a land-based moving vehicle 310 according to one embodiment of the present invention. The system 300 comprises the vehicle 310, containing a computer 320 running computer software 330, an inertial measurement unit (IMU) 350, an odometry readout system 360, a GPS system 370, and an environmental or LIDAR system 380. The vehicle 310 provides power to devices 320-380. As with the mapping variation discussed above, the computer 320 runs software 330 which outputs location estimates for vehicle 310 based on data from location sensors 350, 360, and 370 and environment sensors 380. In the preferred embodiment, sensors 350-380 used for localization are identical to sensors 150-180, respectively, used for mapping, though no such restriction need apply to other embodiments and it is understood that the sensors attached to vehicle 310 and connected to computer 320 for localization could differ in quantity, type, or specifications to those attached to vehicle 110 and connected to computer 120 for mapping. Computer 320 incorporates a storage medium 390 with sufficient storage to maintain a copy of a map 201.

In the preferred embodiment of the invention, system 100 and system 200 perform mapping of a segment of the environment, creating map 201 of this segment. At a later time, system 300 drives through this segment of the environment and uses software 330, sensors 350-380, and map 201 to continuously output estimates of the location of vehicle 310.

Software 130 logs data from sensors 150-180 to the hard disk drive 190 of computer 120 as the vehicle travels through the section of the environment to be mapped. These data are recorded at various rates. For example, the GPS 170, IMU 150, and odometry 160 data may be recorded at 200 Hz while the LIDAR data 180 may be recorded at 75 Hz. These data are stored in a computer log file 198.

Log file 198 may be post-processed, either in system 100 or system 200, using available software that implements a Kalman filter for data smoothing. In this manner, discontinuities in sensor data such as GPS signals are filtered and a smooth stream of position estimations with improved accuracy is saved to an intermediate log file 199 in the preferred embodiment.

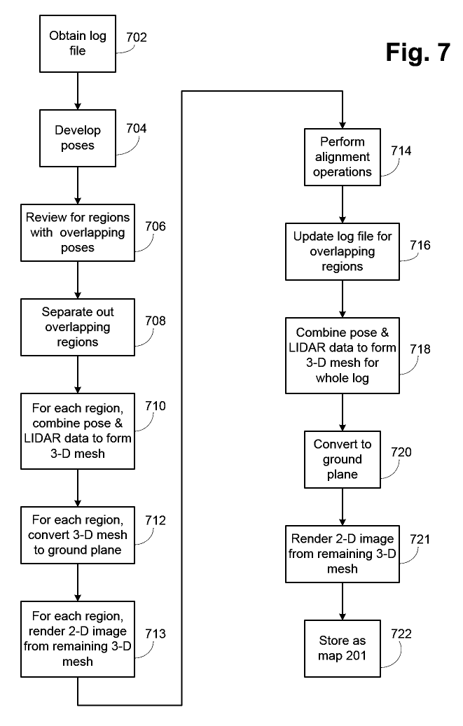

Referring then to FIG. 7, a flowchart of the mapping operations is shown. In step 702 the log file 199 is read. In step 704 the various poses of the vehicle at each position at which the GPS, IMU and odometry data was recorded are developed. If no GPS data is available, only the IMU and odometry data is used. In step 706 the poses of the log file 199 are reviewed to determine if there are regions with overlapping poses. If so, then in step 708 the overlapping regions are separated out for processing. In step 710, for each region, the poses and the relevant LIDAR data for that pose are combined to form a 3-D polygon mesh for that particular region. The software 230 creates a three-dimensional polygon mesh of quadrilaterals wherein the vertices of each quadrilateral are defined by a LIDAR scan at a particular angle, a LIDAR scan at the next scan angle, and the two LIDAR scans at the same angles at the next time step in log file 199. The intensity of each vertex is obtained directly from the intensity reading of the respective LIDAR scan, and the intensities on the face of each quadrilateral are smoothly interpolated between the vertices.

In step 712 the 3-D mesh is converted to a ground plane or near ground plane representation. The simplest way to perform this conversion is to simply delete any elements which have a z axis value greater than a predetermined value. Other more sophisticated techniques can be used if desired. The remaining data is then effectively a 2-D reflectivity map or representation of the environment. This conversion results in a number of holes in the data where outliers existed, i.e. where elements not forming part of the ground plane such as vehicles and so on were present. By removing the outliers from the calculations at this stage, later mapping and localization operations are improved as they ignore points with no data. In step 713 the remaining portions of the 3-D mesh, the ground plane portion, are used to render a 2-D image of the region. In step 714 the 2-D images for the regions that overlap are aligned. More details on the alignment operations are described below, but briefly, the optimal shift is found via a least squares problem. Between any two position labels, the preferred embodiment assumes the existence of two slack variables, one that measures the relative error in x direction, and one that measures the error in y direction. The preferred embodiment adjusts the position data by minimizing the sum of all squared slack variables, under the constraint established by the ground map alignment. In step 716 the log file 199 is updated for the overlapping regions so that in those regions higher confidence log file entries are present for later operations.

In step 718, for the entire log file, the pose information and the LIDAR data are combined to form 3-D meshes, thus creating a 3-D environment for the entire area which has been recorded. In step 720 this entire 3-D mesh is then converted to a ground plane or near ground plane representation, again with outliers and other data not on or near the ground plane being deleted. In step 721 this ground plane portion is used to render a 2-D image. This 2-D representation is then stored in step 722 as map 201. In the preferred embodiment, map 201 may optionally be saved as a collection of small images instead of one large image, so that significant regions without intensity data need not be stored in the map. Consequently, the storage space required for map 201 is linear rather than quadratic in the distance traversed by the vehicle.

Certain aspects of the map generation are now described in more detail. The following equations are for the more general case, where rotational displacements, as well as x and y displacements, of poses are addressed. The preferred embodiment is simplified from the equations and assumes only x and y displacements. The preferred embodiment uses a version of the GraphSLAM algorithm, described in S. Thrun, W. Burgard, and D. Fox, Probabilistic Robotics, MIT Press, Cambridge, Mass., 2005, which is hereby incorporated by reference, in developing the map 201. This description uses terminology from this text, and extends it to the problem of road surface mapping.

In GraphSLAM, the vehicle transitions through a sequence of poses as mentioned above. In urban mapping, poses are three-dimensional vectors, comprising the x-y coordinates of the vehicle, along with its heading direction (yaw); the remaining three dimensions (z, roll, and pitch are irrelevant for this problem). Let xₜ denote the pose at time t. Poses are linked together through relative odometry data, acquired from the vehicle's inertial guidance system.

xₜ=g(uₜ,xₜ₋₁)+εₜ

### Here g is the non-linear kinematic function that links poses xₜ₋₁; xₜ and odometry measurements, denoted uₜ. The variable εₜ is a Gaussian noise variable with zero mean and covariance Rₜ.

In log-likelihood form, each odometry measurement induces a nonlinear quadratic constraint of the form

(xₜ−g(uₜ,xₜ₋₁))^{T}Rₜ⁻¹(xₜ−g(uₜ,xₜ₋₁))

### These constraints can be thought of as edges in a sparse Markov graph.

As described above, in the preferred approach, the map 201 is a 2-D data structure which assigns to each x-y location in the environment an infrared reflectivity value (which can be thought of as a gray-level in a B/W image) based on the reflectivity or intensity values obtained from the LIDAR system 180. Thus, the ground map can be viewed as a high-resolution photograph of the ground with an orthographic camera. As seen in the various Figures, lane markings have a higher reflectivity than pavement and so are very apparent in the views.

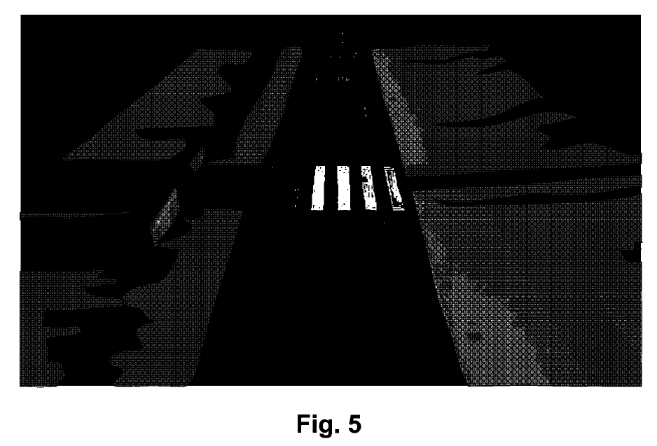

To eliminate the effect of moving or movable objects in the map, referred to as outliers, the preferred approach fits a ground plane to each laser scan, and only retains measurements that coincide with this ground plane. As a result, only the ground or near ground are being mapped. Moving vehicles are automatically discarded from the data. For example, the cross-hatched areas of FIG. 5 illustrate the portions to be discarded.

For any pose xₜ and any (fixed and known) laser angle relative to the vehicle coordinate frame αₜ, the expected infrared reflectivity can easily be calculated. Let hᵢ (m; xᵢ) be this function, which calculates the expected laser reflectivity for a given map m, a robot pose xₜ, and a laser angle αᵢ. Model the observation process as follows

zₜⁱ=hᵢ(m,xₜ)+δₜⁱ

### Here δₜⁱ is a Gaussian noise variable with mean zero and noise covariance Qₜ.

In log-likelihood form, this provides a new set of constraints, which are of the form

(zₜⁱ−hᵢ(m,x))^{T}Qₜ⁻¹(zₜⁱ−hᵢ(m,xₜ))

### The unknowns in this function are the poses {xₜ} and the map m.

In outdoor environments, a vehicle can use GPS for localization. GPS offers the advantage that its error is usually limited to a few meters. Let yₜ denote the GPS signal for time t. (For notational convenience, treat yₜ as a 3-D vector, with the yaw estimate simply set to zero and the corresponding noise covariance in the measurement model set to infinity). At first glance, one might integrate GPS through an additional constraint in the objective function J. The resulting constraints could be of the form

$${\sum }_{t} {( {x}_{t} - {y}_{t} )}^{T} {Γ}_{t}^{- 1} ( {x}_{t} - {y}_{t} )$$

where Γₜ is the noise covariance of the GPS signal. However, this form assumes that GPS noise is independent. In practice, GPS is subject to systematic noise. This is because GPS is affected through atmospheric properties that tend to change slowly with time.

The preferred approach models the systematic nature of the noise through a Markov chain, which uses GPS bias term bₜ as a latent variable. The assumption is that the actual GPS measurement is corrupted by an additive bias bₜ, which cannot be observed (hence is latent but can be inferred from data). This model yields constraints of the form

$${\sum }_{t} {( {x}_{t} - ( {y}_{t} + {b}_{t} ) )}^{T} {Γ}_{t}^{- 1} ( {x}_{t} - ( {y}_{t} + b ) )$$

In this model, the latent bias variables bₜ are subject to a random walk of the form

bₜ=γbₜ₋₁+βₜ

### Here βₜ is a Gaussian noise variable with zero mean and covariance sₜ. The constant γ<1 slowly pulls the bias bt towards zero (e.g., =0:999999).

Putting this all together, obtain the goal function

$$\begin{matrix}J = {\sum }_{t} {( {x}_{t} - g ( {u}_{t} , {x}_{t - 1} ) )}^{T} {R}_{t}^{- 1} ( {x}_{t} - g ( {u}_{t} , {x}_{t - 1} ) ) + \\ {\sum }_{t , i} {( {z}_{t}^{i} - {h}_{i} ( m , {x}_{t} ) )}^{T} {Q}_{t}^{- 1} ( {z}_{t}^{i} - {h}_{i} ( m . {x}_{t} ) ) + \\ {\sum }_{t} {( {x}_{t} - ( {y}_{t} + {b}_{t} ) )}^{T} {Γ}_{t}^{1} ( {x}_{t} - ( {y}_{t} + {b}_{t} ) ) + \\ {\sum }_{t} {( {b}_{t} - γ {b}_{t - 1} )}^{T} {S}_{t}^{1} ( {b}_{t} - γ {b}_{t - 1} )\end{matrix}$$

The preferred approach uses conjugate gradient to iteratively optimize J. Unfortunately, optimizing J directly is computationally infeasible.

A key step in GraphSLAM, which is adopted here, is to first integrate out the map variables. In particular, instead of optimizing Jover all variables {xₜ}, {bₜ}, and m, first optimize a modified version of J that contains only poses {xₜ} and biases {bₜ}, and then compute the most likely map. This is motivated by the fact that the map variables can be integrated out in the SLAM joint posterior. Since nearly all unknowns in the system are with the map, this makes the problem of optimizing J much easier and can be solved efficiently. Road surface patches that are only seen once during mapping have no bearing in the pose estimation. Hence it is safe to remove the associated constraints from the goal function J. As far as the poses are concerned, this is still the identical goal function.

Of concern, however, are places that are seen more than once. Those do create constraints between pose variables from which those places were seen. These constraints correspond to the loop closure problem in SLAM. To integrate those map variables out, the preferred approach uses a highly effective approximation known as map matching. Map matching compares local submaps to find the best alignment. The preferred approach implements map matching by first identifying regions of overlap, which will then form the local maps. By just operating on regions of overlap and using those results to update the overall map, the optimization problem is simplified by orders of magnitude. A further optimization is based on exploiting the linear nature of the corrections which occur in this map matching and pose updating.

A region of overlap is the result of driving over the same terrain twice. Formally it is defined as two disjoint sequences of time indices, t1, t2, . . . and s1, s2, . . . , such that the corresponding grid cells in the map show an overlap that exceeds a given threshold θ.

Once such a region is found, the preferred approach builds two separate maps, one using only data from t1, t2, . . . , and the other only with data from s1, s2 . . . . It then searches for the alignment that maximizes the measurement probability, assuming that both adhere to a single maximum likelihood infrared reflectivity map in the area of overlap.

More specifically, a linear correlation field is computed between those maps, for different x-y offsets between these images. Because both maps are incomplete, the preferred approach only computes correlation coefficients from elements whose infrared reflectivity value is known. In cases where the alignment is unique, a single peak in this correlation field is found. The peak of this correlation field is then assumed to be the best estimate for the local alignment. The relative shift is then labeled δₛₜ, and the resulting constraint of the form above is added to the objective J.

This leads to the introduction of the following constraint in J:

(xₜ+δₛₜ−xₛ)^{T}Lₛₜ(xₜ+δₛₜ−xₛ)

Here δₛₜ is the local shift between the poses xₛ and xₜ, and Lₛₜ, is the strength of this constraint (an inverse covariance).

Replacing the map variables in J with this new constraint is clearly approximate; however, it makes the resulting optimization problem tractable. This results in a modified goal function, that replaces the many terms with the measurement model by a small number of between-pose constraints. It is of the form:

$$\begin{matrix}{J}^{′} = {\sum }_{t} {( {x}_{t} - g ( {u}_{t} , {x}_{t - 1} ) )}^{T} {R}_{t}^{- 1} ( {x}_{t} - g ( {u}_{t} , {x}_{t - 1} ) ) + \\ {\sum }_{t} {( {x}_{t} - ( {y}_{t} + {b}_{t} ) )}^{T} {Γ}_{t}^{- 1} ( {x}_{t} - ( {y}_{t} + {b}_{t} ) ) + \\ {\sum }_{t} {( {b}_{t} - γ {b}_{t - 1} )}^{T} {S}_{t}^{- 1} ( {b}_{t} - γ {b}_{t - 1} ) + \\ {\sum }_{t} {( {x}_{t} + {δ}_{st} - {x}_{s} )}^{T} {L}_{st} ( {x}_{t} + {δ}_{st} - {x}_{s} )\end{matrix}$$

Notice that J′ does not contain any map variables m. The set of poses is then easily optimized using conjugate gradient descent (CG). After the poses are known, simply fill in all map values for which one or more measurements are available, using the average infrared reflectivity value for each location in the map (which happens to be the maximum likelihood solution under the Gaussian noise model). This is equivalent to optimize the missing constraints

$${J}^{″} = {\sum }_{t , i} {( {z}_{t}^{i} - {h}_{i} ( m , {x}_{t} ) )}^{T} {Q}^{- 1} ( {z}_{t}^{i} - {h}_{i} ( m , {x}_{t} ) )$$

under the assumption that the poses {xₜ}, are known.

Optimizing J′ and then J″ is done off-line by software 230. For the type of maps relevant to this description, the process of finding a suitable map takes only a few seconds; it requires less time than the acquisition of the data.

Given the corrected vehicle trajectory, it is straightforward to render the map images. It is preferred to utilize hardware accelerated OpenGL to render smoothly interpolated polygons whose vertices are based on the distances and intensities returned by the three lasers as the vehicle traverses its trajectory. The images are saved in a format which breaks rectangular areas into square grids and only squares with data are saved and can be rendered at 5-cm resolution faster than real-time.

Software 230 includes in map file 201 header data which includes information such as the resolution of the map and the global coordinates of a reference point within the map, if available.

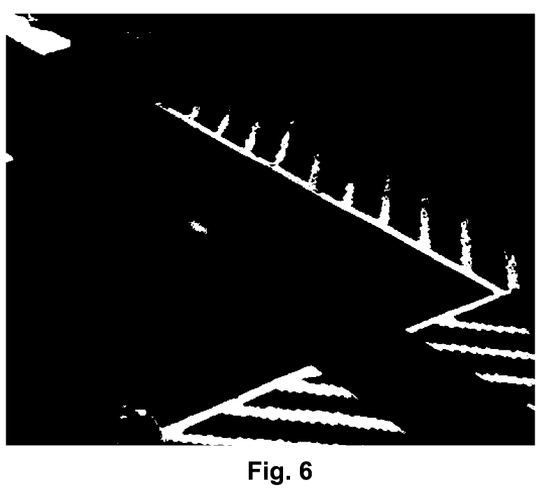

Vehicle 310 drives through the environment that is covered by map 201. Computer 320 runs software 330 which uses map 201 and sensor data 350-380 to provide continuous location estimates relative to map 201. Software 330 continuously maintains an estimate of vehicle location. A particle filter is utilized, wherein multiple discrete vehicle estimates 700 are tracked as shown in FIG. 6.

The preferred approach utilizes the same latent variable model discussed above. However, to achieve real-time performance, a particle filter is preferably utilized, known in robotics as Monte Carlo localizer. The preferred approach maintains a three-dimensional pose vector (x, y, and yaw). Further, to correct for environment-related changes of infrared reflectivity (e.g., wet versus dry surface), the preferred approach also maintains a variable that effectively gamma-corrects the perceived road brightness.

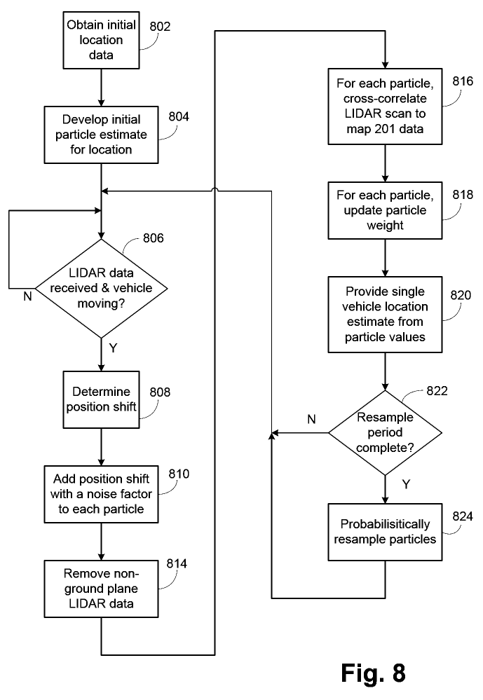

Referring then to FIG. 8, a flowchart of localization operation using particle filters is illustrated. In step 802 the initial location data is obtained, such as when a vehicle is first turned on, from the initial GPS readings, but if no GPS data is present, then the last known location is utilized. In step 804 an initial particle estimate is developed for the particular location. Preferably the particles are spread out uniformly in a small area around the initial location. In step 806 a determination is made as to whether LIDAR data has been received and the vehicle is in motion. In the preferred embodiment LIDAR data is received at a lower frequency, such as 72 Hz, than the other data, so this would be least frequent and thus best trigger event for a particle update. If the vehicle is not moving there clearly is no reason to update the location. In step 808 if data has been received, the position shift from the last calculation set is determined based on the GPS, IMU and odometry data. If no GPS data is available, only the IMU and odometry data is used. In step 810 this position shift determination value plus a particular noise factor is added to the location for each particle in the particle filter. The noise component is used to enable the particle filter to track changing GPS drift. The noise component may be chosen among various probability distributions including a simple gaussian distribution; in the preferred embodiment it is based on perturbing of a simple vehicle motion model.

In step 814 any non- or non-near ground plane LIDAR data is removed. In step 816, for each particle, this ground plane LIDAR data is then cross-correlated to the map data for the region in which the vehicle is traveling. In the preferred embodiment the mean squared error between intensities of map 201 and the corresponding intensities from the projected LIDAR scans are compared, and in step 818 the weight of each particle is multiplied by the reciprocal of this error to update the weight of each particle. Software 330 ignores LIDAR scans which fall outside a tolerance of the ground plane and similarly ignores LIDAR scans which fall on a region of map 201 which contains no data. In this manner, dynamic obstacles, which, in general, do not occur on the ground plane itself, are not factored into the location estimates by software 330. This embodiment is therefore particularly robust to dynamic obstacles such as pedestrians, bicycles, and other vehicles, generally outliers. If available, the indicated GPS location of the vehicle may also be incorporated into the weight, which is particularly useful when GPS data is first received after a period without GPS data.

In step 820 a single or most likely vehicle location estimate is obtained by utilizing the various particle values. The most likely location is preferably computed by taking an average of all current particle locations weighted by the particle weights. This location estimate, preferably in global coordinates, can then be used to locate the vehicle on the map, as on a navigation screen or in navigation processing in an unmanned vehicle or for lane location, for example. In addition to providing a single estimate of the vehicle location, in the preferred embodiment further statistics are provided, such as the uncertainty of the vehicle location as measured by the standard deviation of the particles.

In step 822 a determination is made whether a resample period has been completed. It is necessary to occasionally resample the particles by removing particles which are of very low accuracy and providing additional higher accuracy particles, generally by duplicating particles randomly so that higher weight particles tend to be duplicated, though providing some particles at the current GPS location may also provide a better estimation, to be utilized in the operation. If it is not time, control returns to step 806 to again wait for the next set of LIDAR data. If the resample period has been completed in step 824, the particles are probabilistically resampled. In the preferred embodiment the low weight particles are removed and duplicated particles, generally high weight particles, are incorporated. Control proceeds to step 806 after step 824 to again wait for LIDAR data so that a loop thus is fully developed and positions are currently continually updated as the vehicle moves.

Depending on the type of position data, post-processing of log file 198 is not strictly necessary. Although post-processing will generally improve accuracy and data consistency, a map 201 can still be generated from real-time data, particularly from odometry sensors.

In another embodiment, absolute position estimates are unavailable in log file 198, for example because GPS was not used. In this case software 230 dynamically generates position estimates based on available odometry data 160 and/or IMU data 150 using a vehicle motion model which relates these sensor data to vehicle position changes.

Instead of, or in addition to saving a two-dimensional map, software 230 may save the three dimensional data directly to a map file 201.

In an alternative embodiment, software 330 is augmented to directly compare distance information from LIDAR scans to distance information in a 3-D representation of map 201, in addition to comparing intensity information. The additional information provided by distance allows further accuracy to be obtained at the expense of computational efficiency. In one embodiment, kernel density (KD) tree lookups are used to compare distances. In another embodiment, a separate filter is further employed to reduce the effects of dynamic obstacles which are present in LIDAR scans but not in map 201.

In another embodiment of the invention, system 100 and 200 map an environment multiple times, wherein vehicle 110 drives through the environment multiple times and log files 198 and 199 are created, from which multiple map files 201 are created independently. Subsequently, software 230 merges the multiple map files 201 and outputs a single merged map file which incorporates the data from the individual map files. The merging process can reduce the effect of dynamic obstacles by choosing to incorporate LIDAR scans which occur closer to the ground plane, among other possibilities. Additionally, in the event that vehicle 110 drives a slightly different route each time, the individual map files 201 will contain data which partially cover different sections of the environment, and these sections can be merged together into one larger cohesive map file.

Localization techniques other than a particle filter may be used. The vehicle location estimate may be represented, among other possibilities, as a single Gaussian distribution, as a multi-hypothesis Gaussian distribution, as a histogram, or any other representation that represents the position of the vehicle.

In another embodiment, software 330 is augmented to handle varying weather conditions. When LIDAR scans are projected into space and compared to the same locations in map 201, instead of computing mean squared error between intensities of map 201 and scans 380, deviations from the average of each are compared, thereby eliminating global effects such as roads which have been darkened by rain. This may be in replacement of or in addition to the gamma correction described above. In another embodiment, software 330 dynamically derives a mathematical mapping function which maps intensities from map 201 to intensities observed in laser scans and applies this transformation to values from map 201 before performing a direct comparison. One such implementation comprises treating the weather-related gamma as a latent variable and thus includes a slowly-changing gamma as part of the state vector of the particle filter. In yet another embodiment, these two methods are combined.

In an alternative embodiment, instead of fixing the number of particles at a constant value, the number of particles is dynamically adjusted based on factors such as CPU availability and location estimation uncertainty.

Another embodiment of the present invention comprises the use of an arbitrary mobile robotic platform in lieu of a traditional vehicle.

Many alternative embodiments comprising various sensor choices are easily conceivable based on the present invention. For example, the system can be adapted to function with a camera or cameras in addition to, or instead of, laser scanners. Furthermore, many types of location or position sensing devices other than those detailed herein may be utilized.

The algorithms and modules presented herein are not inherently related to any particular computer, vehicle, sensor, or other apparatus. Various general-purpose systems can be used with programs in accordance with the teachings herein, or it may prove convenient to construct more specialized apparatuses to perform the method steps. In addition, the present embodiments are not described with reference to any particular vehicle, sensor specification, computer operating system, or programming language. It will be appreciated that a variety of programming languages, sensor types, and vehicle platforms can be used to implement the teachings of the invention as described herein. Furthermore, as will be apparent to one of ordinary skill in the relevant art, the modules, features, attributes, methodologies, and other aspects of the invention can be implemented as software, hardware, firmware, or any combination of the three. Additionally, the present invention is not restricted to implementation in any specific operating system or environment or on any vehicle platform.

The invention described herein in its preferred embodiment has demonstrated to be robust and accurate at mapping and localizing a vehicle on city streets and freeways. The mapping algorithm was tested successfully on a variety of urban roads. A challenging mapping experiment was a four-mile urban loop which was driven twice, though the preferred algorithm works on arbitrarily large datasets from much longer distances. The preferred algorithm automatically identified and aligned 148 match points between the two loops, corrected the trajectory, and output consistent imagery at 5-cm resolution.

The online systems 100 and 300 are able to run in real-time on typical computer hardware and are capable of tracking a vehicle's location to within 5 to 10 cm accuracy, as compared to the 50-100 cm accuracy achievable with the best GPS systems. It is noted that this better than 10 cm, preferably 5 cm, accuracy is readily obtained when clean lines are present in the map 201, such as lane stripes, stop lines and the like. This condition most often occurs in the lateral direction due to the frequency of lane markers. The longitudinal accuracy often varies more widely as highly defined objects such as crosswalk lines or stop lines are not present as often, though accuracy will improve to 5 to 10 cm as they are approached, with dashed lines or reflectors then forming the primary cleanly defined lines. While strongly reflective markings enable the best localization performance, it should be noted that the invention described herein in its preferred embodiment maintains the ability to improve localization accuracy over traditional GPS/IMU systems even in the absence of strong or distinct markings, provided that there exists meaningful variation in the reflectivity of the ground, such as is common in typical unmarked roads.

This invention has also been shown to afford highly accurate localization even in the absence of GPS data during the localization phase given a fixed ground map. Using vehicle odometry data alone, system 300 is still capable of tracking vehicle location to within 5-10 cm accuracy on a typical street.

Embodiments of the invention have demonstrated robustness in the face of dynamic obstacles that were not present in the map file. When driving next to vehicles and other obstacles that are not incorporated into the map file, the system successfully ignores those obstacles and functions properly.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

1. A method for collecting data for mapping an arbitrary outdoor environment comprising:
driving a vehicle equipped with sensors which allow data to be collected which provides an accuracy of better than 10 cm when processed through the arbitrary outdoor environment; and
logging the data received from the sensors as the vehicle is driven.

2. The method of claim 1, wherein a portion of the sensors sense vehicle position and a portion of the sensors sense vehicle environment.

3. The method of claim 2, wherein the vehicle position sensors include at least one of global positioning system, inertial measurement and odometry.

4. The method of claim 3, wherein the vehicle position sensors include all three sensors.

5. The method of claim 3, wherein the vehicle environment sensors include at least one of laser and camera.

6. The method of 5, wherein the vehicle environment sensors provide distance and intensity data.

7. The method of claim 2, wherein the vehicle environment sensors include at least one of laser and camera.

8. The method of 7, wherein the vehicle environment sensors provide distance and intensity data.

9. A method for collecting data for mapping an arbitrary outdoor environment comprising:
driving a vehicle equipped with at least one vehicle position sensor and at least one vehicle environment sensor; and
logging the data received from the sensors as the vehicle is driven,
wherein the vehicle environment sensor provides distance and intensity data.

10. The method of claim 9, wherein the vehicle environment sensor includes at least one of laser and camera.

11. The method of claim 10, wherein the vehicle position sensor includes at least one of global positioning system, inertial measurement and odometry.

12. The method of claim 11, wherein the vehicle position sensor includes all three sensors.

13. A vehicle for collecting data for mapping an arbitrary outdoor environment comprising:
a base vehicle;
a computer located in said base vehicle;
a data storage device located in said base vehicle and coupled to said computer;
sensors located in said base vehicle and coupled to said computer to allow data to be collected which provides an accuracy of better than 10 cm when processed through the arbitrary outdoor environment; and
software located on said computer which logs the data received from said sensors as said base vehicle is driven.

14. The vehicle of claim 13, wherein a portion of said sensors sense base vehicle position and a portion of said sensors sense base vehicle environment.

15. The vehicle of claim 14, wherein said vehicle position sensors include at least one of global positioning system, inertial measurement and odometry.

16. The vehicle of claim 15, wherein said vehicle position sensors include all three sensors.

17. The vehicle of claim 15, wherein said vehicle environment sensors include at least one of laser and camera.

18. The vehicle of 17, wherein said vehicle environment sensors provide distance and intensity data.

19. The vehicle of claim 14, wherein said vehicle environment sensors include at least one of laser and camera.

20. The vehicle of 19, wherein said vehicle environment sensors provide distance and intensity data.

21. A vehicle for collecting data for mapping an arbitrary outdoor environment comprising:
a base vehicle;
a computer located in said base vehicle;
a data storage device located in said base vehicle and coupled to said computer;
at least one vehicle position sensor located in said base vehicle and coupled to said computer;
at least one vehicle environment sensor located in said base vehicle and coupled to said computer; and
software on said computer which logs the data received from said vehicle position and vehicle environment sensors as said base vehicle is driven,
wherein said vehicle environment sensor provides distance and intensity data.

22. The vehicle of claim 21, wherein said at least one vehicle environment sensor includes at least one of laser and camera.

23. The vehicle of claim 22, wherein said at least one vehicle position sensor includes at least one of global positioning system, inertial measurement and odometry.

24. The vehicle of claim 23, wherein said at least one vehicle position sensor includes all three sensors.

25. A method for developing a map of an arbitrary outdoor environment comprising:
reading logged data, the logged data including vehicle position data and vehicle environment data, the logged data having been obtained as the vehicle was driven over the arbitrary outdoor environment to be mapped; and
operating on the logged data to produce a map having an accuracy of better than 10 cm.

26. The method of claim 25, wherein the operations on the logged data include simultaneous localization and mapping operations and operations to merge the vehicle position data and the vehicle environment data.

27. The method of claim 26, wherein the logged data includes regions of overlap, and wherein said regions of overlap are aligned and the logged data is updated prior to performing full map operations.

28. A method for developing a map of an arbitrary outdoor environment comprising:
reading logged data, the logged data including vehicle position data and vehicle environment data, the logged data having been obtained as the vehicle was driven over the arbitrary outdoor environment to be mapped; and
operating on the logged data to produce a 2-D map which is an approximate ground plane of the arbitrary outdoor environment being mapped.

29. The method of claim 28 wherein the operations on the logged data include simultaneous localization and mapping operations and operations to merge the vehicle position data and the vehicle environment data.

30. The method of claim 29, wherein the logged data includes regions of overlap, and wherein said regions of overlap are aligned and the logged data is updated prior to performing full map operations.

31. A computer readable medium or media having computer-executable instructions stored thereon for performing a method of developing a map of an arbitrary outdoor environment, the method comprising:
reading logged data, the logged data including vehicle position data and vehicle environment data, the logged data having been obtained as the vehicle was driven over the arbitrary outdoor environment to be mapped; and
operating on the logged data to produce a map having an accuracy of better than 10 cm.

32. The computer readable medium or media of claim 31, wherein the operations on the logged data include simultaneous localization and mapping operations and operations to merge the vehicle position data and the vehicle environment data.

33. The computer readable medium or media of claim 32, wherein the logged data includes regions of overlap, and wherein said regions of overlap are aligned and the logged data is updated prior to performing full map operations.

34. A computer readable medium or media having computer-executable instructions stored thereon for performing a method of developing a map of an arbitrary outdoor environment, the method comprising:
reading logged data, the logged data including vehicle position data and vehicle environment data, the logged data having been obtained as the vehicle was driven over the arbitrary outdoor environment to be mapped; and
operating on the logged data to produce a 2-D map which is an approximate ground plane of the arbitrary outdoor environment being mapped.

35. The computer readable medium or media of claim 34 wherein the operations on the logged data include simultaneous localization and mapping operations and operations to merge the vehicle position data and the vehicle environment data.

36. The computer readable medium or media of claim 35, wherein the logged data includes regions of overlap, and wherein said regions of overlap are aligned and the logged data is updated prior to performing full map operations.

37. A method of localizing a vehicle in an arbitrary outdoor environment comprising:
driving a vehicle equipped with sensors which allow data to be collected which provides an accuracy of better than 10 cm when processed through the arbitrary outdoor environment;
receiving the data from the sensors as the vehicle is driven;
operating on the received vehicle sensor data in conjunction with a map of the arbitrary outdoor environment through which the vehicle is being driven, the map having an accuracy of better than 10 cm; and
providing a vehicle localization estimate based on the operations.

38. The method of claim 37, wherein a portion of the sensors sense vehicle position and a portion of the sensors sense vehicle environment.

39. The method of claim 38, wherein the vehicle position sensors include at least one of global positioning system, inertial measurement and odometry.

40. The method of claim 39, wherein the vehicle position sensors include all three sensors.

41. The method of claim 39, wherein the vehicle environment sensors include at least one of laser and camera.

42. The method of 41, wherein the vehicle environment sensors provide distance and intensity data.

43. The method of claim 38, wherein the vehicle environment sensors include at least one of laser and camera.

44. The method of 43, wherein the vehicle environment sensors provide distance and intensity data.

45. The method of claim 38, wherein only the vehicle environment sensors are providing data, and
wherein the operations on the received vehicle data are performed using only the vehicle environment sensor data.

46. The method of claim 38, wherein the vehicle positions sensors providing data do not include global positioning system data, and
wherein the operations on the received vehicle data are performed without utilizing global positioning system data.

47. A method of localizing a vehicle in an arbitrary outdoor environment comprising:
driving a vehicle equipped with at least one vehicle position sensor and at least one vehicle environment sensor, wherein the vehicle environment sensor provides distance and intensity data;
receiving the data from the sensors as the vehicle is driven;
operating on the received vehicle sensor data in conjunction with a map of the arbitrary outdoor environment through which the vehicle is being driven; and
providing a vehicle localization estimate based on the operations.

48. The method of claim 47, wherein the vehicle environment sensor includes at least one of laser and camera.

49. The method of claim 48, wherein the vehicle position sensor includes at least one of global positioning system, inertial measurement and odometry.

50. The method of claim 49, wherein the vehicle position sensor includes all three sensors.

51. The method of claim 47, wherein only the vehicle environment sensor is providing data, and
wherein the operations on the received vehicle data are performed using only the vehicle environment sensor data.

52. The method of claim 47, wherein the vehicle positions sensors providing data do not include global positioning system data, and
wherein the operations on the received vehicle data are preformed without utilizing global positioning system data.

53. A vehicle of localizing a vehicle in an arbitrary outdoor environment comprising:
a base vehicle;
a computer located in said base vehicle;
a data storage device located in said base vehicle and coupled to said computer and storing a map of the arbitrary outdoor environment through which said base vehicle is being driven, said map having an accuracy of better than 10 cm;
sensors which allow data to be collected which provides an accuracy of better than 10 cm when processed; and
software located on said computer which:
receives the data from said sensors as said base vehicle is driven;
operates on said received vehicle sensor data in conjunction with said map; and
provides a vehicle localization estimate based on said operations.

54. The vehicle of claim 53, wherein a portion of said sensors sense vehicle position and a portion of said sensors sense vehicle environment.

55. The vehicle of claim 54, wherein said vehicle position sensors include at least one of global positioning system, inertial measurement and odometry.

56. The vehicle of claim 55, wherein said vehicle position sensors include all three sensors.

57. The vehicle of claim 55, wherein said vehicle environment sensors include at least one of laser and camera.

58. The vehicle of 57, wherein said vehicle environment sensors provide distance and intensity data.

59. The vehicle of claim 54, wherein said vehicle environment sensors include at least one of laser and camera.

60. The vehicle of 59, wherein said vehicle environment sensors provide distance and intensity data.

61. The vehicle of claim 54, wherein only said vehicle environment sensors are providing data, and
wherein said operations on said received vehicle data are performed using only said vehicle environment sensor data.

62. The vehicle of claim 54, wherein said vehicle positions sensors providing data do not include global positioning system data, and
wherein said operations on said received vehicle data are performed without utilizing global positioning system data.

63. A vehicle of localizing a vehicle in an arbitrary outdoor environment comprising:
a base vehicle;
a computer located in said base vehicle;
a data storage device located in said base vehicle and coupled to said computer and storing a map of the arbitrary outdoor environment through which said base vehicle is being driven;
at least one vehicle position sensor located in said base vehicle and coupled to said computer;
at least one vehicle environment sensor located in said base vehicle and coupled to said computer, wherein said vehicle environment sensor provides distance and intensity data; and
software located on said computer which:
receives said data from said at least one vehicle environment sensor and said at least one vehicle position sensor as said base vehicle is driven; and
operates on said received vehicle sensor data in conjunction with said map; and
provides a vehicle localization estimate based on said operations.

64. The vehicle of claim 63, wherein said at least one vehicle environment sensor includes at least one of laser and camera.

65. The vehicle of claim 64, wherein said at least one vehicle position sensor includes at least one of global positioning system, inertial measurement and odometry.

66. The vehicle of claim 65, wherein said at least one vehicle position sensor includes all three sensors.

67. The vehicle of claim 63, wherein only said at least one vehicle environment sensor is providing data, and
wherein said operations on the received vehicle data are performed using only said at least one vehicle environment sensor data.

68. The vehicle of claim 63, wherein said at least one vehicle position sensor providing data does not include global positioning system data, and
wherein said operations on the received vehicle data are performed without utilizing global positioning system data.

69. A computer readable medium or media having computer-executable instructions stored thereon for performing a method of localizing a vehicle in an arbitrary outdoor environment, the method comprising:
driving a vehicle equipped with sensors which allow data to be collected which provides an accuracy of better than 10 cm when processed through the arbitrary outdoor environment;
receiving the data from the sensors as the vehicle is driven;
operating on the received vehicle sensor data in conjunction with a map of the arbitrary outdoor environment through which the vehicle is being driven, the map having an accuracy of better than 10 cm; and
providing a vehicle localization estimate based on the operations.

70. The computer readable medium or media of claim 69, wherein a portion of the sensors sense vehicle position and a portion of the sensors sense vehicle environment.

71. The computer readable medium or media of claim 70, wherein the vehicle position sensors include at least one of global positioning system, inertial measurement and odometry.

72. The computer readable medium or media of claim 71, wherein the vehicle position sensors include all three sensors.

73. The computer readable medium or media of claim 71, wherein the vehicle environment sensors include at least one of laser and camera.

74. The computer readable medium or media of 73, wherein the vehicle environment sensors provide distance and intensity data.

75. The computer readable medium or media of claim 70, wherein the vehicle environment sensors include at least one of laser and camera.

76. The computer readable medium or media of 75, wherein the vehicle environment sensors provide distance and intensity data.

77. The computer readable medium or media of claim 70, wherein only the vehicle environment sensors are providing data, and
wherein the operations on the received vehicle data are performed using only the vehicle environment sensor data.

78. The computer readable medium or media of claim 70, wherein the vehicle positions sensors providing data do not include global positioning system data, and
wherein the operations on the received vehicle data are performed without utilizing global positioning system data.

79. A computer readable medium or media having computer-executable instructions stored thereon for performing a method of localizing a vehicle in an arbitrary outdoor environment, the method comprising:
driving a vehicle equipped with at least one vehicle position sensor and at least one vehicle environment sensor, wherein the vehicle environment sensor provides distance and intensity data;
receiving the data from the sensors as the vehicle is driven;
operating on the received vehicle sensor data in conjunction with a map of the arbitrary outdoor environment through which the vehicle is being driven; and
providing a vehicle localization estimate based on the operations.

80. The computer readable medium or media of claim 79, wherein the vehicle environment sensor includes at least one of laser and camera.

81. The computer readable medium or media of claim 80, wherein the vehicle position sensor includes at least one of global positioning system, inertial measurement and odometry.

82. The computer readable medium or media of claim 81, wherein the vehicle position sensor includes all three sensors.

83. The computer readable medium or media of claim 79, wherein only the vehicle environment sensor is providing data, and
wherein the operations on the received vehicle data are performed using only the vehicle environment sensor data.

84. The computer readable medium or media of claim 79, wherein the vehicle positions sensors providing data do not include global positioning system data, and
wherein the operations on the received vehicle data are performed without utilizing global positioning system data.
